(19) United States
(12) Patent Application Publication
(10) Pub. No.: US 2020/0000129 A1
(43) Pub. Date: Jan. 2, 2020

(54) DEHYDRATION ASSEMBLY

(71) Applicants: Mikayla Sullivan, Ames, IA (US); Ella Gehrke, Ames, IA (US); Elise Kendall, Roseville, MN (US); Clayton Mooney, Ames, IA (US)

(72) Inventors: Mikayla Sullivan, Ames, IA (US); Ella Gehrke, Ames, IA (US); Elise Kendall, Roseville, MN (US); Clayton Mooney, Ames, IA (US)

(21) Appl. No.: 16/449,695

(22) Filed: Jun. 24, 2019

Related U.S. Application Data
(60) Provisional application No. 62/691,333, filed on Jun. 28, 2018.

(51) Int. Cl. A23L 3/40; A23L 3/00

(52) U.S. Cl. CPC A23L 3/40; A23V 2002/00; A23L 3/001

(57) ABSTRACT

In accordance with this disclosure, a dehydrating system may include a lid with apertures configured to allow air to exit the dehydrating system, a base with a plurality of apertures configured to allow air to enter the dehydrating system, a first tray between the lid and the base, the first tray having a first receiver, a second receiver, and a stop, a second tray between the lid and the first tray, the second tray having a first receiver, a second receiver, and a stop, a first connecting member having a first end in a receiver of the base and a second end in the second receiver of the first tray, a second connecting member having a first end in the first receiver of the of the first tray and a second end in the second receiver of the second tray, and a sleeve surrounding the first and second tray.

### CROSS-REFERENCE TO RELATED APPLICATIONS

This application claims the benefit of U.S. Patent Application No. 62/691,333 filed with the United States Patent and Trademark Office on Jun. 28, 2018, the entire contents of which are herein incorporated by reference.

### BACKGROUND

### 1. Field

Example embodiments relate to a dehydration assembly.

### 2. Description of the Related Art

Dehydration assemblies are well-known in the art. Dehydration is used to avoid food loss which occurs for a variety of reasons, such as through transportation or storage. In its most simple form, dehydration of food products, such as fruit, vegetable, or grain takes ripe food product and removes moistures to dry the food product to prevent spoilage and rotting.

Dehydration for food preservation has been used for a long time as an effective and inexpensive means to make food last longer. As the transportation of food product has increased, so has the need for dehydration. Also, dehydration of food product prevents spoilage, increases food supply, and reduces cost.

While present dehydration devices are useful, they are difficult to assemble and do not provide storage for the dehydrated food product. Further, conventional devices are difficult to transport and do not provide sufficient air circulation to prevent rotting while dehydrating.

### SUMMARY

Example embodiments relate to a dehydration assembly.

In accordance with this disclosure, a dehydrating system may include a lid, a base, a plurality of trays, a plurality of connection members, and a sleeve surrounding the plurality of trays. In at least one nonlimiting example embodiment the lid may have a plate with an upper surface, a lower surface and a plurality of apertures configured to allow air to exit the dehydrating system. The base may be arranged below the lid and the base may have a plate with an upper surface, a lower surface, and a plurality of apertures configured to allow air to enter the dehydrating system. The plurality of trays may include a first tray between the lid and the base. The first tray may have an upper surface, a lower surface, an exterior peripheral edge, a plurality of apertures, a first receiver, a second receiver, and a stop. The plurality of trays may further include a second tray between the lid and the first tray and the second tray have an upper surface, a lower surface, an exterior peripheral edge, a plurality of apertures, a first receiver, a second receiver, and a stop. The plurality of connecting members may include a first connecting member having a first end in a receiver of the base and a second end in the second receiver of the first tray. The plurality of connecting members may further include a second connecting member having a first end in the first receiver of the of the first tray and a second end in the second receiver of the second tray.

### BRIEF DESCRIPTION OF THE DRAWINGS

Example embodiments are described in detail below with reference to the attached drawing figures, wherein:

FIG. 1 is a view of a perspective view of a dehydration system in accordance with example embodiments;

FIG. 2 is a side view of the dehydration system in accordance with example embodiments;

FIGS. 3 is a top view of the dehydration system in accordance with example embodiments;

FIG. 4 is a perspective view of a lid in accordance with example embodiments;

FIG. 5 is a top view of the lid in accordance with example embodiments;

FIG. 6 is a cross-section view of the lid in accordance with example embodiments;

FIG. 7 is a perspective view of a base in accordance with example embodiments;

FIG. 8 is a top view of the base in accordance with example embodiments;

FIG. 9 is a cross-section view of the base in accordance with example embodiments;

FIG. 10 is a perspective view of a tray in accordance with example embodiments;

FIG. 11 is a top view of the tray in accordance with example embodiments;

FIG. 12 is a side view of the base in accordance with example embodiments;

FIG. 13 is a perspective view of a connecting member in accordance with example embodiments;

FIG. 14 is a top view of the connecting member in accordance with example embodiments;

FIG. 15 is a side view of the connecting member in accordance with example embodiments;

FIG. 16 is a plan view of a sheet in accordance with example embodiments;

FIG. 17 is a perspective view of the sheet in accordance with example embodiments;

FIG. 18 is a perspective view of the sleeve in accordance with example embodiments; and

FIG. 19 is an exploded view of the dehydration system in accordance with example embodiments.

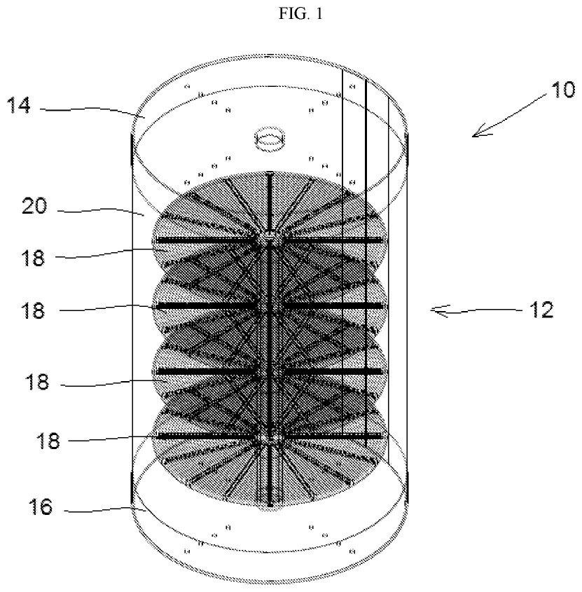

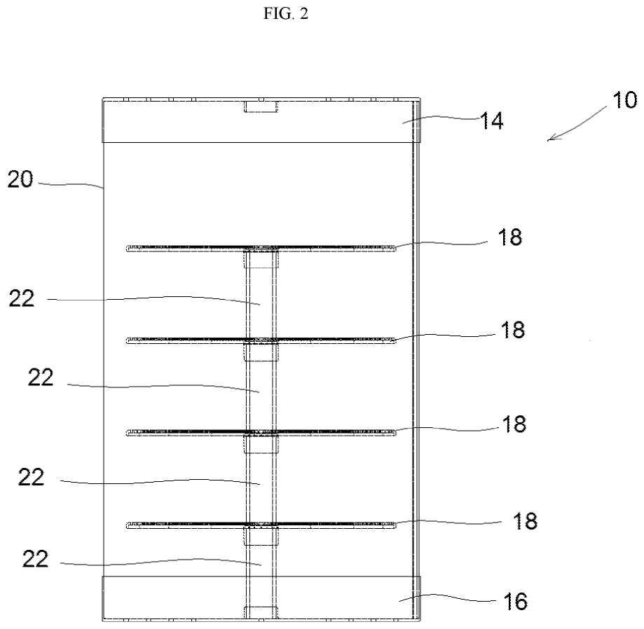

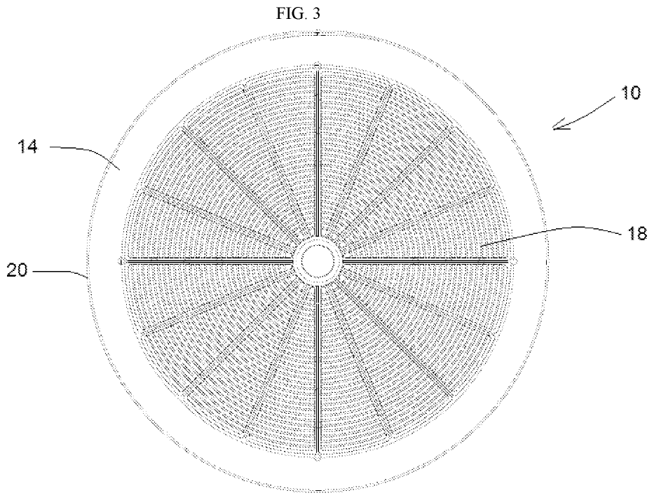

### DETAILED DESCRIPTION

Example embodiments will now be described more fully with reference to the accompanying drawings. Example embodiments are not intended to limit the invention since the invention may be embodied in different forms. Rather, the example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example Embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a dehydration system.

With reference to the figures, a dehydration system 10 is presented. Dehydration system 10 is formed of any suitable size, shape and design. In the arrangement shown, as one example, dehydration system 10 has a dehydration chamber 12 arranged between a lid 14 and a base 16. The dehydration chamber 12 may include one or more trays 18 upon which items, for example, food items, may be placed for dehydration. Surrounding the one or more trays 18 is a sleeve 20 which may, together with the lid and base 14 and 16, enclose the one or more trays 18. In at least one nonlimiting example embodiment, connecting members 22 may be used to connect trays 18 to one another and/or connect a tray 18 to at least one of the lid 14 and the base 16.

Lid

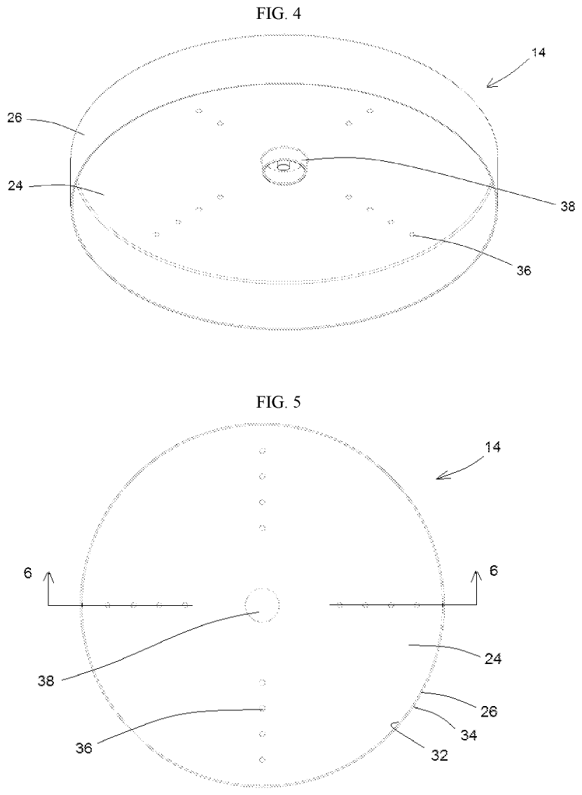

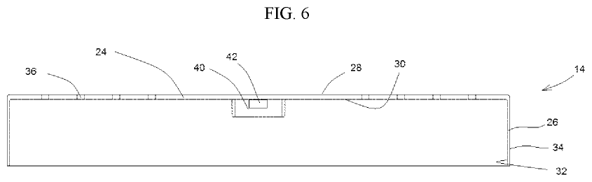

Referring to FIGS. 4-6, the lid 14 may be a substantially integral structural made from a casting process. To that end, the lid 14 may be made from any suitable material which includes, but it not limited to, metal and/or plastic. This aspect of the disclosure, however, is not meant to limit the invention as the lid 14 may be made from materials other than metal or plastic, for example, a composite material, and may be an assembly of prefabricated parts which are assembled into a unitary structure. As such, the lid 14 may be constructed as an assembly rather than as an integral structure formed through a casting process.

As shown in FIGS. 4-6, the lid 14 may include a plate 24 surrounded by a sidewall 26. In the embodiment of FIG. 4, the plate 24 may resemble a circular disk having an outer surface 28 and an inner surface 30 with the sidewall 26 resembling a cylinder arranged at the circumference of the plate 24. The sidewall 26 likewise includes an inner surface 32 and an outer surface 34. The plate 24 may include a plurality of apertures 36 which, as will be explained below, may allow for air to flow out of the dehydration system 10. In FIGS. 4-6, four sets of apertures 36 are shown with each set being arranged in a substantially straight line, however, this pattern of apertures 36 is for purposes of illustration only as the pattern of apertures 36 is relatively unimportant. For example, rather than having four sets of apertures 36 arranged in four lines, the apertures 36 may be arranged as six rows of apertures 36 arranged in six lines. As yet another example, the apertures 36 may be arranged in a grid like pattern. As such, the particular arrangement of apertures 36 is not critical so long as the arrangement allows for proper ventilation of the dehydration system 10.

As shown in FIGS. 4-6, the lid 14 may include a receiver 38. The receiver 38 may take on various forms. In one nonlimiting example embodiment, the receiver 38 may resemble a short hollow cylinder having a receiving area 40 configured to receive a connecting member 22. In another embodiment, the receiver 38 may resemble a truncated cone having a hollow receiving area 40 for receiving a connecting member 22. As shown in the various figures the receiver 38 may be arranged at a middle of the plate 24 and may appear to protrude from the middle of the plate 24. In one nonlimiting example embodiment a post 42 may be present in the receiving area 40. The post 42 may be configured to insert into the connecting member 22 when the connecting member 22 is configured as a hollow member or a solid member with a cavity at one end. For example, if the connecting member 22 is embodied as a hollow cylinder or a solid cylinder with a cavity at one end, the post 42 may resemble a short cylindrical post having an outer diameter configured to insert into the cavity or the hollow portion of the cylinder.

Base

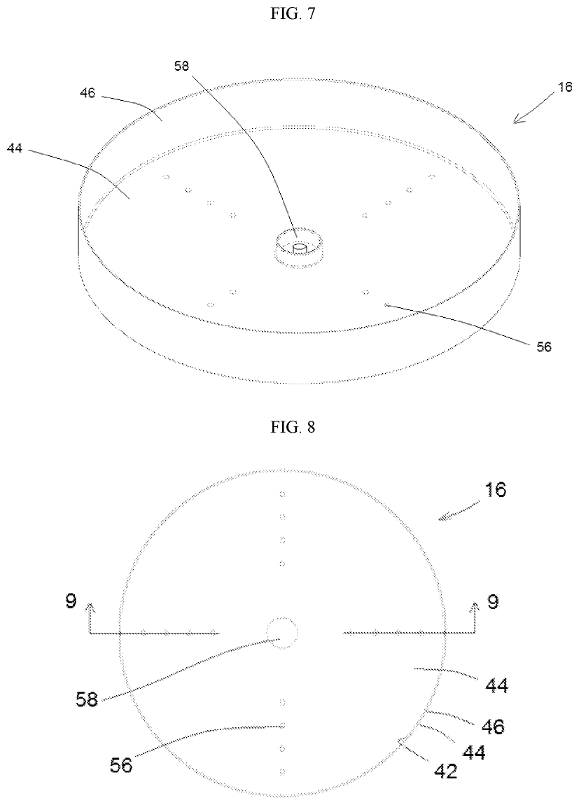

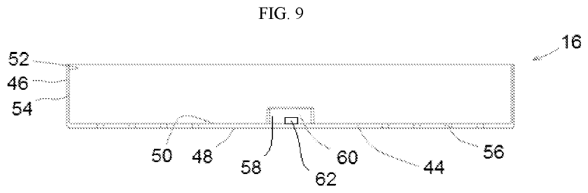

Referring to FIGS. 7-9, the base 16 may be a substantially integral structural made from a casting process. To that end, the base 16 may be made from any suitable material which includes, but it not limited to, metal and/or plastic. This aspect of the disclosure, however, is not meant to limit the invention as the base 16 may be made from another type of material, for example, a composite material. Furthermore, the base 16 may actually be an assembly of prefabricated parts which are assembled into a unitary structure. As such, the base 14 may be constructed as an assembly rather than as an integral structure formed through casting.

As shown in FIGS. 7-9, the base 16 may include a plate 44 surrounded by a sidewall 46. In the embodiment of FIGS. 7-9, the plate 44 may resemble a circular disk having an outer surface 48 and an inner surface 50 with the sidewall 46 resembling a cylinder arranged at the circumference of the plate 44. The sidewall 46 likewise includes an inner surface 52 and an outer surface 54. The plate 44 may include a plurality of apertures 56 which, as will be explained below, may allow for air to flow into the dehydration system 10. In FIGS. 7-9, four sets of apertures 56 are shown with each set being arranged in a substantially straight line, however, this pattern of apertures 56 is for purposes of illustration only as the pattern of apertures 56 is relatively unimportant. For example, rather than having four sets of apertures 56 arranged in four lines, the apertures 56 may be arranged as six rows of apertures 56 arranged in six lines. As yet another example, the apertures 56 may be arranged in a grid like pattern. As such, the particular arrangement of apertures 56 is not critical so long as the arrangement allows for proper influx of air into the system 10.

As shown in FIGS. 7-9, the base 16 may include a receiver 58. The receiver 58 may take on various forms. In one nonlimiting example embodiment, the receiver 58 may resemble a short hollow cylinder having a receiving area 60 configured to receive a connecting member 22. In another embodiment, the receiver 58 may resemble a truncated cone having a hollow receiving area 60 for receiving a connecting member 22. As shown in the various figures the receiver 58 may be arranged at a middle of the plate 44. In one nonlimiting example embodiment a post 62 may be present in the receiving area 60. The post 62 may be configured to insert into the connecting member 22 when the connecting member 22 is configured with a cavity or as a hollow member. For example, if the connecting member 22 is embodied as a hollow cylinder or a solid cylinder having a cavity at one end, the post 62 may resemble a short cylindrical post having an outer diameter configured to insert into a cavity or the hollow portion of the cylinder.

Tray

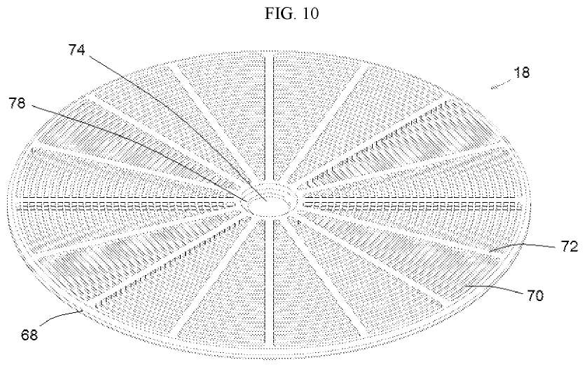

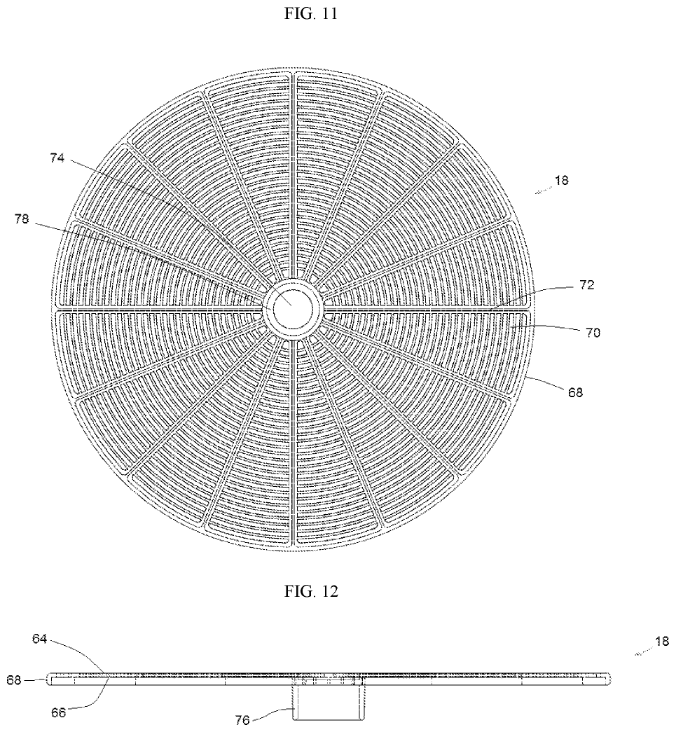

Referring to FIGS. 10-12, the tray 18 may resemble a disk having an upper surface 64, a lower surface 66, and a circular peripheral edge 68. The tray 18 may include a plurality of apertures 70 which, in at least one nonlimiting example embodiment, may be arcuate in shape. This aspect of the invention, however, is not meant to limit the invention as the apertures 70 may have another shape. For example, rather than having arcuate shaped apertures 70, the tray 18 may have a plurality of circular, rectangular, or triangular holes so long as the holes provide allow for sufficient flow of air through the tray 18 for purposes of dehydration. To reinforce and stiffen the tray 18, the tray 18 may include reinforcing ribs 72.

In the nonlimiting example of FIGS. 10-12, the tray 18 may include an upper receiver 74 for receiving a connecting member 22 and a lower receiver 76 for receiving a connecting member 22. The upper receiver 74 may resemble a cylindrical depression in the upper surface 66 which terminates in a stop 78 to prevent a connecting member 22 from passing completely through the upper receiver 74. In one embodiment, the stop 78 may resemble a ledge or a protrusion. The upper receiver 74 may have an opening large enough to accommodate an end of a connecting member 22. The lower receiver 76 may resemble a short hollow cylinder having another opening large enough to accommodate another connecting member 22. The stop 78 prevents either connecting member 22 from passing through the tray 18

Connecting Member

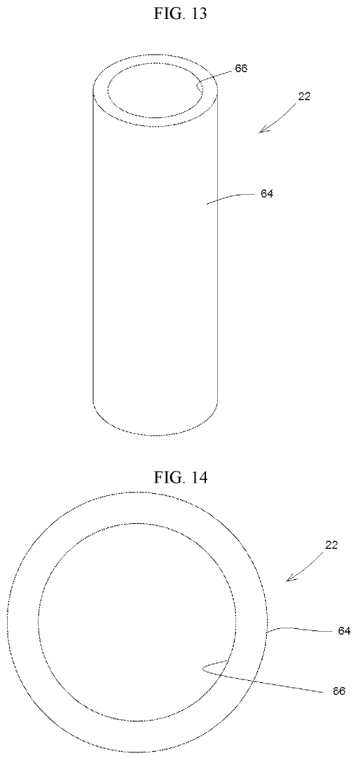

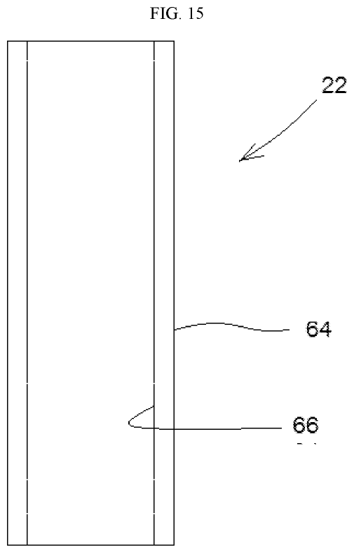

FIGS. 13-15 illustrate an example of a connecting member 22 usable with system 10. As shown in FIGS. 13-15, the connecting member 22 may resemble a cylinder which may be hollow. Thus, the connecting member 22 may have an outer surface 64 and an inner surface 66. In the event the connecting member 22 resembles a short cylinder, an outside diameter thereof is configured to insert into the receiving areas of upper end member 14, the lower end member 16, and trays 18.

Sleeve

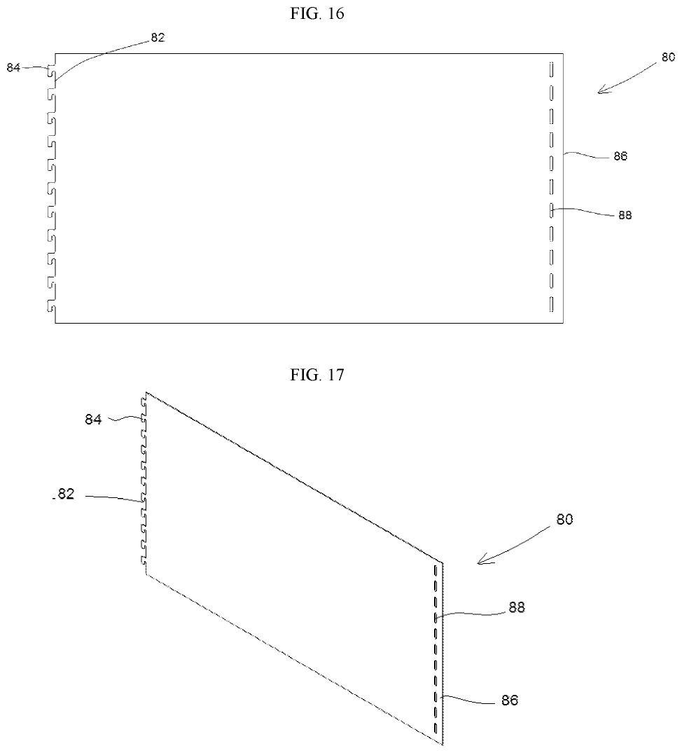

FIGS. 16 and 17 are views of a sheet 80 that may be usable to form the sleeve 20 of the dehydration system 10. As shown in FIGS. 16 and 17, the sheet 80 may resemble a substantially flat thin sheet having a very low bending resistance (allowing the sheet to bend or roll) while having a relatively high in plane stiffness. Any suitable material may be used to form sheet 80. For example, transparent or semitransparent plastics sheets, as well as polycarbonate resin thermoplastic sheets (for example, Lexan) are well suited for sheet 80.

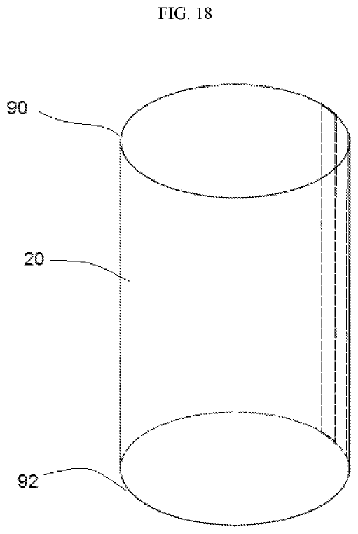

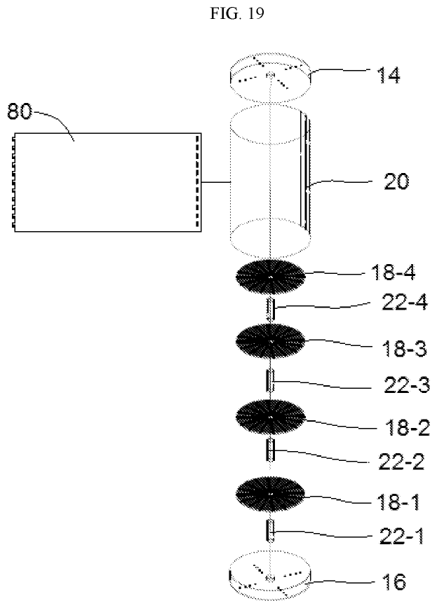

In the nonlimiting example of FIGS. 16 and 17, sheet 80 may resemble a rectangular sheet having a first end 82 with tabs 84 and a second end 86 with slots 88. With this, sheet 80 may be easily rolled into a cylindrical shape wherein the tabs 84 are inserted into the slots 88 to form the sleeve 20 as shown in FIG. 18. Although the use of slots 88 and tabs 84 have been found to very useful, they are not necessary as one could use another means to fix the first end 82 of the sheet 80 to the second end 86 of the sheet 80 to form the sleeve 20. For example, adhesives, screws, tapes, clips and other means may be used to attach the first end 82 of the sheet 80 to the second end 86 of the sheet 88.

In the example embodiment illustrated herein the sleeve 20 may have a first end 90 and a second end 92. The lid 14 of the dehydrating apparatus 10 may be placed on the first end 90 of the sleeve 20. In the nonlimiting example embodiment disclosed herein, the diameter of the sleeve 20 may be about the same size or slightly smaller than a diameter associated with the inside of the side wall 26 of the lid 14. Thus, when the lid 20 is placed on the first end 90 of the sleeve 20, the first end of the sleeve 20 may contact the inner surface 30 of the plate 24 of the lid 14. Because there is a relatively small to no gap between an outer surface of the sleeve 20 an the inner surface 32 of the sidewall 26 of the lid 14, lateral movement of the first end 90 of the sleeve 20 is restrained by the side wall 26 of the lid 14. In this way, the first end 90 of the sleeve 20 is captured by the lid 14. Similarly, the diameter of the sleeve 20 may be about the same size or slightly smaller than the diameter associated with the inside of the side wall 46 of the base 16. Thus, when the sleeve 20 is placed inside the side wall 46 of the base 16 the second end 92 of the sleeve 20 may contact the inner surface 50 of the plate 44 of the base 16. Because there is a relatively small to no gap between an outer surface of the sleeve 20 and the inner surface 52 of the side wall 46 of the base 16, lateral movement of the second end 92 of the sleeve 20 with respect to the base 16 is restrained by the side wall 46 of the base 16. In this way, the second end 92 of the sleeve 20 is captured by the base 20.

Method of Assembling Dehydrator

FIG. 19 illustrates an exploded view of the dehydrator 10 and may also serve to serve as a guide in assembling the dehydrator. Though the invention is not limited to the following, one skilled in the art could assemble the dehydrator 10 by first rolling sheet 80 into a cylinder to form the sleeve 20. The skilled artisan could then insert a first connecting member 22-1 into the receiver 58 of the base 16. The artisan could then place a first tray 18-1 onto the first connecting member 22-1 so that an end of the first connecting member 22-1 is inserted into the lower receiver 76 of the first tray 18-1. The artisan could then insert a second connecting member 22-2 into the upper receiver 74 of the first tray 18-1. The artisan could then place a second tray 18-2 onto the second connecting member 22-2 so that an end of the second connecting member 22-2 is inserted into the lower receiver 76 of the second tray 18-2. The artisan could then insert a third connecting member 22-3 into the upper receiver 74 of the second tray 18-2. The artisan could then place a third tray 18-3 onto the third connecting member 22-3 so that an end of the third connecting member 22-3 is inserted into the lower receiver 76 of the third tray 18-2. The artisan could then insert a fourth connecting member 22-4 into the upper receiver 74 of the third tray 18-3. The artisan could then place a fourth tray 18-4 onto the fourth connecting member 22-4 so that an end of the fourth connecting member 22-4 is inserted into the lower receiver 76 of the fourth tray 18-4. Food items may then be placed on the various trays. Thereafter, the sleeve 20 may then be placed over the trays 18-1, 18-2, 18-3, and 18-4 and into the base 16 and cover 14 may be placed on the sleeve 20.

In one nonlimiting example embodiment, the base 16 may be intentionally made of a dark material. Since the material is dark the material would warm more quickly and to a greater extent than the other materials present in the dehydrator 10 if the dehydrator 10 were exposed to the sun. As a consequence, air at a bottom of the dehydrator would warm and naturally travel upwards. This air flow would draw air into the dehydrator 10 via the apertures 56 of the base which would leave through the apertures 36 of the cover 14.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A dehydrating system comprising:
a lid having a plate with an upper surface, a lower surface and a plurality of apertures configured to allow air to exit the dehydrating system;
a base below the lid, the base having a plate with an upper surface, a lower surface, a plurality of apertures configured to allow air to enter the dehydrating system, and a receiver;
a first tray between the lid and the base, the first tray having an upper surface, a lower surface, an exterior peripheral edge, a plurality of apertures, a first receiver, a second receiver, and a stop;
a second tray between the lid and the first tray, the second tray having an upper surface, a lower surface, an exterior peripheral edge, a plurality of apertures, a first receiver, a second receiver, and a stop;
a first connecting member having a first end in the receiver of the base and a second end in the second receiver of the first tray;
a second connecting member having a first end in the first receiver of the of the first tray and a second end in the second receiver of the second tray; and
a sleeve surrounding the first and second tray.

2. The dehydrating system of claim 1, wherein the sleeve is made of a polycarbonate resin thermoplastic sheet.

3. The dehydrating system of claim 2, wherein the thermoplastic sheet has tabs arranged at a first end of the sheet and slots at a second end of the sheet.

4. The dehydrating system of claim 1, wherein the lid includes a side wall, the base includes a side wall, and a first end of the sleeve is captured by the side wall of the lid and a second end of the sleeve is captured by the side wall of the base.

5. The dehydrating system of claim 1, wherein the base is comprised of a dark color to facilitate warming of air near a bottom of the dehydrating system.

6. The dehydrating system of claim 1, wherein the first and second connecting members are hollow cylindrical members.

7. The dehydrating system of claim 1, wherein the sleeve is a cylindrical member.

8. The dehydrating system of claim 7, wherein the plate of the lid and the plate of the base are circular plates having diameters about the same size as a diameter of the sleeve.

9. The dehydrating system of claim 1, wherein the lid's plate is a circular plate and the lid further includes a side wall along a perimeter of the lid's plate which resembles a short cylinder,
the base's plate is a circular plate and the base further includes a side wall along a perimeter of the base's plate which resembles a short cylinder,
the sleeve is a cylindrical structure having diameter;
an inner diameter of the lid's side wall is about the same size as the diameter of the sleeve, and
an inner diameter of the base's side wall is about the same size as the diameter of the sleeve.

10. The dehydrating system of claim 1, wherein a first end of the sleeve directly contacts the plate of the lid and a second end of the sleeve directly contacts the plate of the base.
